(19) United States
(12) Patent Application Publication
(10) Pub. No.: US 2006/0097815 A1
(43) Pub. Date: May 11, 2006

(54) Method and system for memory signal transmission

(76) Inventors: Charles Grasso, Louisville, CO (US); Michael John Bazata, Elizabeth, CO (US); Ren Allen Nicolaisen, Littleton, CO (US)

Correspondence Address: ECHOSTAR SATELLITE LLC, LEGAL DEPARTMENT, 9601 SOUTH MERIDIAN BOULEVARD, ENGLEWOOD, CO, 80112, US

(21) Appl. No.: 11/247,476

(22) Filed: Oct. 11, 2005

Related U.S. Application Data
(60) Provisional application No. 60/617,112, filed on Oct. 8, 2004.

(51) Int. Cl. H01P 3/08

(52) U.S. Cl. 333/1; 333/238

(57) ABSTRACT

The present invention sets forth a method and apparatus for transmitting signals. Specifically, the present invention sets forth a method and apparatus for transmitting signals between memory and one or more processors on a printed circuit board.

### RELATED APPLICATIONS

This application claims the benefit of U.S. Provisional Application Ser. No. 60/617,112, filed Oct. 8, 2004 and titled GROUNDED CO-PLANAR WAVEGUIDE, which application is hereby incorporated herein by reference in its entirety.

### BACKGROUND OF THE INVENTION

This invention generally relates to the design of printed circuit boards (PCBs) that contain memory and a microprocessor (i.e., “processor”). The design and development of printed circuit boards (PCBs) increasingly requires that transmission of data between a memory and processor at higher speeds. As data transmission rates on PCBs increase, there arises a need to treat PCB signal lines or traces between memory and a processor as transmission lines. Two signal lines can be considered transmission lines provided that the transmission lines have a defined construction with respect to each other and one of the signal lines is defined as the return path (or ground). A transmission line design is uniquely defined by its Characteristic Impedance (Zo). Typically, the more tightly coupled a signal trace is to its return path, the lower its Characteristic Impedance.

At higher signal frequencies (and correspondingly lower rise-times), naturally-occurring electromagnetic effects become more pronounced as signals propagate along a trace from a source to a destination (the “load”), incorporating the trace's return path. If the signal transmission medium is poorly designed, the signal may suffer distortion or emit RF interference. This distortion may result in performance degradation or even failure of system functionality.

One distortionary effect is called “crosstalk.” Crosstalk is the creation of unwanted signals in adjacent PCB signal lines or traces. Crosstalk may produce interference that makes it difficult for the load to discriminate between the desired signal and unwanted RF signals (i.e., interference or noise). Crosstalk may also result in signal degradation since the fundamental shape of the incoming signal could be altered by the unwanted interference.

The current state of the art for electronic systems to avoid these problems is to implement a low impedance “microstrip” PCB configuration. PCB microstrip design typically consists of two or more stacked layers and dielectric material that are adjacent in the vertical axis. Layers may consist of two or more traces (i.e., the “SIGNAL1” and “SIGNAL2” layers), a signal reference plane (i.e., “GROUND plane”) and a power plane (i.e., “POWER plane”). A PCB layer stack specifies the arrangement of circuit board layers and dielectric materials. For example, a two-layer PCB design may consist of one signal layer and a ground plane, while a six-layer PCB design may consist of four trace layers, a ground plane and a power plane. A typical four-layer stack microstrip PCB configuration contains two traces that sandwich, in the vertical axis, an adjacent power plane and an adjacent ground plane. In order to implement a low impedance design, the width of the signal trace and/or the spacing of the signal trace with respect to these four PCB layers are manipulated.

The current state of the art for configuring a microstrip PCB creates significant benefits for signal transmission. A microstrip PCB configuration may minimize cross talk between signals by permitting a low impedance distribution with corresponding lower inductance and higher capacitance (thereby maintaining a low impedance distribution). Microstrip PCBs may also permit a larger signal trace surface area to couple to the ground plane, thus enhancing “skin effect” and “proximity effect.” Skin effect is the tendency of high frequency signals to propagate on the surface of the conductor. Proximity effect occurs at relatively low frequencies and is the tendency of the signal to follow the path of least inductance. As such, a signal trace over a ground plane has a non uniform field with the maximum coupling between the trace and the plane. This allows for field cancellation at the points on the transmission line when the flux lines are in opposition, lowering the overall inductance of the signal path, and reducing any RF interference between adjacent traces. Tightly coupled transmission lines are a very desirable property for microstrip PCBs.

However, a big disadvantage of current microstrip PCBs in low-cost consumer-electronics is the cost of the PCB. A PCB that can achieve adequate performance with fewer layers is a correspondingly cheaper and more attractive solution. Typically, a two-layer PCB configuration consisting of a mixture of power/ground and signals is used to reduce production costs where the addition of successive layers imposes greater manufacturing costs. There are two significant disadvantages, however, that plague current two-layer PCBs. First, the signal transmission design of a two-layer microstrip PCB produces inherently higher loop inductance and lower capacitance (and hence higher impedance) that has inherently higher crosstalk and is thus typically results in lower digital speeds. Second, the power distribution of the two-layer PCB is forced to be mixed with the signals and therefore results in much more complicated and expensive microstrip PCBs that employ exclusive power and ground planes.

Accordingly there is a need for a two-layer PCB configuration that solves these disadvantages without requiring production of a more expensive PCB. The present invention provides a solution to this and other problems, and offers other advantages over the prior art.

### BRIEF SUMMARY OF THE INVENTION

The grounded coplanar waveguide (GCWG) corrects these disadvantages with a signal distribution design that allows for fast signal transmission on a cheaper two-layer board. Uniquely, the invention dispenses with the necessity for a ground plane. In place of the ground plane, ground return traces are added on each side of a critical signal or pairs of signals to allow for consistent signal transmission and minimization of crosstalk between the signals. The ground return traces allow significant cost-savings by not requiring addition of a ground layer to the PCB. These and various other features, as well as advantages which characterize the present invention, will be apparent from a reading of the following detailed description and a review of the associated drawings.

### BRIEF DESCRIPTION OF THE DRAWINGS

FIG. 1 is a high level block diagram of an entertainment system using a television converter device of an embodiment of the present invention.

FIG. 2 is a high level block diagram of a television converter device of an embodiment of the present invention.

FIG. 3 is a three-dimensional high level block diagram of an embodiment of the present invention.

FIG. 4 is a cross-sectional diagram of an embodiment of the present invention.

FIG. 5 is a cross-sectional diagram of the field distribution of current of an embodiment of the present invention.

FIG. 6 is a cross-sectional diagram of a second embodiment of the present invention.

### DETAILED DESCRIPTION

In this specification, the present invention will be described using methods and systems related to subscriber satellite television service. This specific description is not meant to limit the invention to that one embodiment. The present invention may also be applicable to cable television systems, broadcast television systems or other television systems. The present invention is also described in terms of digital video recording (DVR) devices. The present invention may also be applicable to digital-versatile-disc (DVD) recording devices or other television recording devices. One skilled in the art will recognize that the present invention can apply elsewhere. For example, the present invention may also be applicable to electronic devices that contain a processor and memory attached to a printed-circuit-board (PCB), including, but not limited to, consumer electronics devices, portable music or video devices, cellular phones, and personal digital assistants or digital cameras.

As a general matter, the disclosure uses the term “signal.” One skilled in the art will recognize that the signal may be any digital or analog signal. Those signals may include, but are not limited to, a bit, a specified set of bits, an A/C signal, or a D/C signal. Uses of the term “signal” in the description may include any of these different interpretations. It will also be understood to one skilled in the art that the term “connected” is not limited to a physical connection but can refer to any means of communicatively or operatively coupling two devices. As another general matter, the disclosure uses the terms “television converter,” “receiver,” “set-top-box,” “television receiving device,” “television receiver,” “television recording device,” “satellite set-top-box,” “satellite receiver,” “cable set-top-box,” “cable receiver,” and “television tuner” to refer interchangeably to a converter device or electronic equipment that has the capacity to acquire, process and distribute one or more television signals transmitted by broadcast, cable, telephone or satellite distributors. “Digital video recorder (DVR)” and “personal video recorder (PVR)” refer interchangeably to devices that can digitally record and play back television signals and that may implement trick functions including, but not limited to, fast-forward, rewind and pause. As set forth in this specification and the figures pertaining thereto, DVR and PVR functionality or devices may be combined with a television converter. The signals transmitted by these broadcast, cable, telephone or satellite distributors may include, individually or in any combination, internet, radio, television or telephonic data or information. One skilled in the art will recognize that a television converter device may be implemented as an external self-enclosed unit, a plurality of external self-enclosed units or as an internal unit housed within a television. One skilled in the art will recognize that the present invention can apply to analog and digital satellite set-top-boxes.

As yet another general matter, it will be understood by one skilled in the art that the term “television” refers to a television set or video display that may contain an integrated television converter device (e.g., an internal cable-ready television tuner housed inside a television) or, alternatively, that is connected to an external television converter device (e.g., an external set-top-box connected via cabling to a television). A further example of an external television converter device is the EchoStar Dish PVR 721, Part Number 106525, combination satellite set-top-box and PVR. For the remainder of this disclosure, specific embodiments will be described using a television converter device that implements satellite technology.

Finally, as a general matter, it should be understood that satellite television signals may be very different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO™, CSPAN™, ABC™, CBS™, or ESPN™. In satellite television, a service provider can also be compared to a “channel.”

The term “channel,” as used in this description, carries a different meaning from its normal connotation. In broadcast television, different analog signals of a television station may be carried on a carrier frequency and its sub-channels. A tuner in a television may then acquire and process these signals. In broadcast television, the term channel has thus become synonymous with the sub-channel or the station on that sub-channel. The normal connotation of the term “channel” is therefore not always appropriate to describe satellite television transmissions where multiple stations may be multiplexed onto a single carrier frequency. Satellite television distributors, however, may organize the satellite data into a group of different “virtual channels.” These virtual channels give the impression that the satellite television programs (the service providers) are placed in channels. This impression may assist user operation of the satellite set-top-box since it models an analog television or analog receiving device. The virtual channels may appear in the electronic program guide (EPG) data and the user may choose programming by selecting a virtual channel. For instance, the user can select HBO, which may be on virtual channel 300, or CSPAN, which may be on virtual channel 210. These service providers or virtual channels are not necessarily carried in the same signal being sent from the same satellite. EPG data may come from a service provider (e.g., HBO), content provider (e.g., Disney), a third party (e.g., TV Guide) or from another outside entity.

Thus, in satellite television service a channel may not be the same as in broadcast television service. Rather, channels may be more properly termed service providers in satellite television service. The term “channel” will be used in this description to describe the service providers and the virtual channels they may occupy.

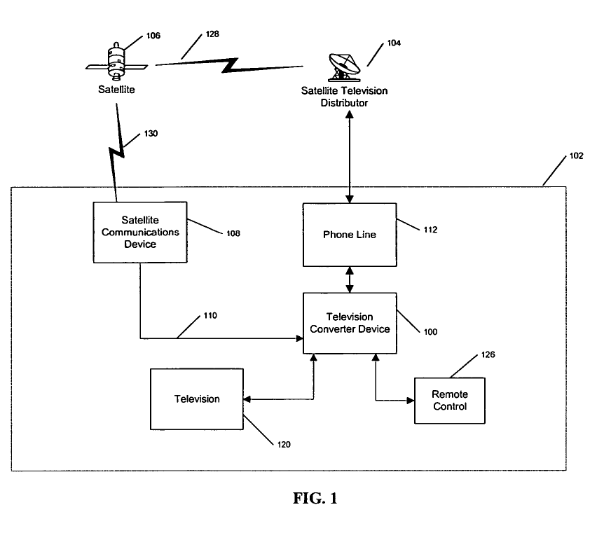

FIG. 1 presents an embodiment of a home entertainment system 102 that includes a television converter device 100 in the form of a satellite set-top-box. Generally, the satellite set-top-box 100 may receive one or more television signals from a cable television distributor, from a broadcast television distributor or from a satellite television distributor 104. As a preferred embodiment, home entertainment system 102 receives signals from satellite television distributor 104. One skilled in the art will recognize that set-top-box 100 may also receive video-digital subscriber line (DSL), DSL, Internet, wireless and other signals from content or video distributors. The satellite set-top-box 100 may process television signals and may send the processed signals to peripheral electronic devices, such as a television 120 and remote control 126. The satellite set-top-box 100 also may accept commands from a remote control 126 or other peripheral electronic devices. More detail about the functionality of the satellite set-top-box 100 is provided below.

To further describe the home entertainment system, embodiments relating to receiving satellite television signals will be explained in more detail. A satellite television distributor 104 may transmit one or more satellite television signals 128 to one or more satellites 106. Satellite television distributors may utilize several satellites 106 to relay the satellite television signals to a subscriber. Each satellite 106 may have several transponders. Transponders transmit the signal 130 from the satellite to the subscriber. For example, these signals 130 may be transmitted at a frequency of 2150 Mhz.

A transponder may also polarize the transmitted signal 130 in several ways. One form of polarization in satellite transmissions is circular polarization. For example, transponders of satellite 106 may transmit two signals (together as signal 130) on the same transponder, one signal that is right-hand polarized and another signal that is left-hand polarized. In other words, two signals may be simultaneously transmitted with opposite polarizations. The opposite polarizations may prevent interference. One skilled in the art will recognize that other ways of polarizing signals are possible.

The polarized signals can be received at satellite communication device 108. The satellite communication device 108 may include one or more of the components that follow. One component of satellite communication device 108 may be a satellite dish. A satellite dish can focus the signal on one or more low-noise block filters (LNBF), also referred to as low-noise block down converters (LNBDC). The LNBFs may de-polarize and initially process the signal. This initial processing may include filtering noise from the signal and down-converting the signal. Down-conversion is sometimes required to transmit the signal 110 through certain cables, such as coaxial cables. The signal 110 arrives at the television converter device 100 via cabling. One skilled in the art will recognize that other methods and other systems of delivering the satellite signal 110 to the satellite set-top-box 100 may be possible.

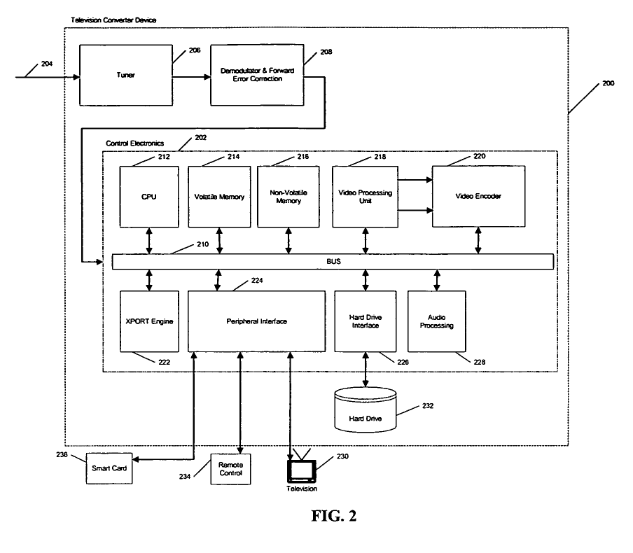

FIG. 2 provides a high level block diagram for the satellite television converter device 100, 200 with DVR functionality in accordance with the present invention.

The signal 110, 204 that arrives at the satellite set top box 200 may undergo extensive processing. The television converter 200 may include one or more tuner devices 206 that may receive a satellite signal 204. In this embodiment, tuner device 206 acquires a satellite signal 204 from satellite television distributor 104. Tuner device 206 may initially process the satellite signal 204. Tuner device 206 may also receive subscriber commands in the form of signals from control electronics unit 202. Signals from control electronics unit 202 may include, but is not limited to, a signal to tune to a transponder as part of the process of selecting a certain channel for viewing on a peripheral device. One skilled in the art would recognize that the tuner device 206 may include fewer, more, or different components.

After receiving the signal 204, one of the first steps may be to demodulate 208 the signal 204. The signal 204 may arrive as an analog signal that “carries” data (e.g., data is modulated onto the analog signal). Demodulation 208 may be accomplished by reversing the modulation process. Modulation can be done in several ways. Modulation may include amplitude modulation (AM) or frequency modulation (FM). If the carried data is digital, modulation methods include, but are not limited to, biphase-shift keying (BPSK), quadraphase-shift keying (QPSK), or eight-phase shift keying (8PSK). One skilled in the art will recognize that other methods of modulating and demodulating the signal 204 may be possible. Another one of the first steps may also be to error check 208 signal 204. One example of error checking 208 is forward error checking (FEC). FEC 208 may include, but is not limited to, inspecting parity bit or bits that may accompany signal 204. One skilled in the art will recognize that many methods for error checking are possible. For the purposes of discussion, an embodiment using digital data will be discussed below. However, one skilled in the art will recognize that systems with analog data or combined analog and digital data are also possible and contemplated herein.

In this embodiment, satellite set-top-box 200 contains control electronics unit 202 that receives satellite signal 204. One skilled in the art will recognize that control electronics 202 may receive other signals, including, but not limited to, signals from a cable or broadcast television distributor. One example of a control electronics unit 202 is the STMicroelectronics STi5517 Low-Cost Interactive Set-top Box Decoder, Part No. 7424736A. In a preferred embodiment, control electronics unit 202 includes discrete electronic components combined into a single circuit with a shared bus 210. In other embodiments, control electronics unit 202 may be configured differently. For example, one or more of the control electronics unit 202 components in set-top-box 200 may be combined or omitted. The control electronics unit 202 may use a custom ASIC, such as from the LSELogic G11 family, or FPGA, such as from the Altera Stratix™ family. As a further example, one or more of the control electronics unit 202 components in set-top-box 200 may not share a bus 210, but may nonetheless be operatively connected by some other means. One skilled in the art will recognize that other configurations of set-top-box 200 and control electronics unit 202 are possible and within the scope of this invention. One skilled in the art will further recognize that some components of set-top-box 200 and control electronics unit 202 may be implemented in hardware or software. The control electronics unit 202 may operate under the control of a software program, firmware program, or some other program stored in memory or control logic. One skilled in the art will also recognize that the control electronics unit 202 may include other electronic components or structures to mediate or process signals.

Control electronics unit 202 may contain one or more central-processing-units (CPUs) 212 or processors. A preferred embodiment of control electronics unit 202 contains a single CPU 212 that is operatively connected to the shared bus. In one embodiment, CPU 212 may be used, among other things, for logical operations for set-top-box 200 functions including, but not limited to, channel selection, recording control, EPG display and control and system maintenance. Examples of commercially available CPUs 212 include the STMicroelectronics Enhanced ST20 32-bit VL-RISC, Motorola 68000 or Intel Pentium processors. One skilled in the art will recognize that the CPU 212 may be integrated with memory or other discrete electronics components.

Control electronics unit 202 may contain one or more volatile memory components 214. Volatile memory components 214 may include, but are not limited to, one or more SDRAM memory chips. Similarly, control electronics unit 202 may also contain one or more non-volatile memory components 216. Non-volatile memory 216 may include one or more memory chips, including, but not limited to, ROM, SRAM, SDRAM and Flash ROM. One skilled in the art will recognize that volatile memory 214 and non-volatile memory 216 may be integrated within other electronics components. One skilled in the art will also recognize that other memory components may be included within set-top-box 200 and control electronics unit 202. One skilled in the art will recognize that memory 214, 216 may be used for many purposes, including, but not limited to, storing EPG data and storing data for use by CPU 212.

In a preferred embodiment, signal 204 is in digital form (e.g., a digital stream) after demodulation and error correction. For example, digital stream 204 may use, but is not limited to using, the digital video broadcasting (DVB) transport standard. The digital stream 204 may be multiplexed and therefore require demultiplexing by XPORT Engine 222. Demultiplexing 222, or demuxing, may include separating the bits of data into separate digital data streams. The digital streams may be packetized. Thus, the multiplexing of the separate digital data streams may not be bit-by-bit but packet-by-packet. The packet size may vary or may be constant. After demuxing 222 the packets, the separate digital data streams may be reassembled by placing related packets together in a continuous data stream 204.

Each of the separate digital data streams may also be encoded. Encoding is a method for representing data. Encoding may allow the data to be compressed. Compression can provide the system with increased bandwidth. One skilled in the art will recognize that several different encoding formats are possible. In satellite television, encoding formats may include the MPEG, MPEG2 or MPEG4 standards. Beyond the raw data, the separate digital data streams may include forward error correction, headers, checksums, or other information. All of this different information may be included in the digital television signal 204 processed by the satellite set-top-box 100. Control electronics unit 202 may therefore include one or more video processing units 218 that, among other video processing operations, may decode encoded signal 204. In a preferred embodiment, video processing unit 218 may include, but is not limited to, a graphics processor, MPEG-2 decoder and a display compositor with separate on-screen display (OSD) control for peripheral devices. One skilled in the art will recognize that video processing unit 218 may also include other electronics, including, but not limited to, alpha blending, antialiasing, antiflutter and antiflicker filters, memory and video-rendering components.

Another discrete electronic component of control electronics unit 202 may be a video encoder unit 220. Video encoder unit 220 may work in combination with or independently from video processing unit 218. Video encoding unit 220 may encode digital stream 204 for output to one or more peripheral devices, including, but not limited to, a television. For example, video encoding unit 220 may encode digital stream 204 for RGB, CVBS, Y/C and YUV outputs. Encoding may allow program data to be compressed. As a preferred embodiment, video encoder 220 may translate digital stream into a signal using the NTSC, PAL or SECAM standards. One skilled in the art will recognize that video encoder unit 220 may include other functionality, may be integrated into other electronic components of satellite set-top-box 200, and may encode digital stream 204 using other standards, including, but not limited to, MPEG and MPEG2.

Control electronics unit 202 may also include one or more hard drive interfaces 226 and hard drives 232. In a preferred embodiment, television converter device 200 contains one hard drive interface 226 and hard drive 232. Hard drive 232 may be used for many purposes, including, but not limited to, storing recorded programs, buffering currently-playing programs (e.g., buffering a program may allow a user to pause or rewind a program), storing EPG data, storing commands or functions for the control electronics unit 202, storing timers or record events, and storing data for other devices within or connected to the satellite set-top-box 200. As another example, hard drive 232 may be used to temporarily store data for processing by CPU 212. In this example, the hard drive 232 may allow the processor 212 to separate EPG data arriving as part of digital stream 208. One skilled in the art will recognize that other storage devices and interfaces may be substituted for hard drive interface 226 and hard drive 232 and are within the scope of this invention. One skilled in the art will also recognize that hard drive interface 226 and hard drive 232 may separately or together include an integrated memory (e.g., a memory buffer, commonly known referred to as cache) and additional processing components or logic. One skilled in the art will also recognize that hard drive interface 226 may be integrated into peripheral interface 224 (described below). Finally, one skilled in the art will recognize that hard drive 232 may be external and connected to satellite set-top-box 200. For example, an external hard drive 232 may be connected to satellite set-top-box 200 using USB 2.0 or IEEE 1394 (FireWire) connections. Such an external hard drive may include a screen for portable viewing of programming stored on it.

An audio processing unit 228 may also be part of the control electronics unit 202. Audio processing unit 228 may decode the digital stream 204 for output to peripheral devices, including, but not limited to, a stereo, television speakers or portable audio or video players. For example, audio processing unit 228 may decode MPEG-1 layers I/II and layer III, Dolby Digital, Dolby ProLogic, SRS/TruSurround encoded audio in digital stream 204. Audio processing unit 228 may include one or more processors, memory components or digital to audio converter (DAC) systems. One skilled in the art will recognize that other audio processing components and functionality may be accomplished using audio processing unit 228.

A satellites set-top-box 200 may be connected to one or more peripheral electronic devices through peripheral interface 224. These peripheral devices may include a stereo, television 230, smart card 236, VCR, or other devices. In a preferred embodiment, home entertainment system 102 minimally contains, but is not limited to, a television 230 and smart card 236. Television 230 may serve many purposes, including, but not limited to, displaying television programming, displaying the EPG, displaying timer conflicts, and displaying other types of data, graphics and programming. Peripheral devices may receive and/or send signals from the satellite set-top-box 200. For instance, the television 230 may receive video and audio signals and a stereo may receive only audio signals. A camcorder, on the other hand, may send video or audio signals to the satellite set-top-box 100 or receive audio and video signals from the set-top-box to record. As another example, peripheral interface 224 may include a processor or other electronic components to permit an interface to content security devices such as an external “smart card.” In this example, peripheral interface 224 may then encrypt or decrypt content for output to other peripheral devices. Thus, peripheral interface 224 may perform one or more functions for multiple peripheral devices, including, but not limited to, the synchronous or asynchronous transfer of data between different peripheral devices (e.g., decrypting content using a smart card peripheral device and outputting decrypted content to a television at the same time). One skilled in the art will recognize that the peripheral devices may include many types of commercially available electronic devices.

The home entertainment system 102 may also include a remote control 126, 234 peripheral device, also sometimes referred to as a remote. The remote control 234 may be used to send commands to the satellite set-top-box 200. The remote control 234 may send commands via a wireless connection using, for example, infrared or UHF transmitters within the remote control 234. One example of an embodiment of a remote controller 234 is the EchoStar Technologies Corporation 721 Platinum Plus Remote, Part Number 121150, that includes an IR transmitter and an ultra high frequency (UHF) transmitter. The remote control 234 may be able to send signals to other peripheral electronic devices that form part of the home entertainment system 102, including, but not limited to, a television, stereo, VCR, or DVD player. The set-top-box 200 may also be able to send signals to the remote control 234, including, but not limited to, signals to configure the remote control 234 to operate other peripheral devices in home entertainment system 102. In some embodiments, the remote control 234 has a set of Light Emitting Diodes (LEDs). Some remote controls may include Liquid Crystal Displays (LCDs) or other screens. The remote control may include buttons, dials, or other man-machine interfaces. While the remote control 234 may often be the common means for a subscriber to communicate with the satellite set-top-box 200, one skilled in the art will recognize that other means of communicating with the set-top-box 200 are available, including, but not limited to attached keyboards, front panel buttons or touch screens.

The satellite set-top-box 200 may also include a remote control interface. A remote control interface may include any means for the user to communicate to the satellite set-top-box 200, and may be implemented using the peripheral interface 224 of control electronics unit 202 or by connecting a peripheral remote control interface device. In a preferred embodiment, a remote control interface may receive commands from one or more different remote controls 234. Remote control 234 may use infrared, UHF, or other communications technology. The remote control interface may therefore translate an input from the user into a format understandable by the control electronics unit 202. The translation systems may include, but are not limited to, electronic receivers and electronic relays. One skilled in the art will recognize that other means to receive and translate user inputs are possible.

Another peripheral device and connection to the satellite set-top-box 200 may include a phone line and modem. Set-top-box 200 may use a modem and phone line to communicate with one or more outside entities or systems (e.g., satellite television distributor 104). The phone line may carry local or long-distance telephone service. One skilled in the art will recognize that the phone line may also carry other services, including, but not limited to, DSL service. These communications may include requesting pay-per-view programming, reporting of purchases (for example, pay-per-view purchases), obtaining updates to subscriber programming (e.g., updating EPG data), or receiving updates to software on the satellite set-top-box 100. For example, the phone line may communicate with the satellite set-top-box 100 using an RJ-11 style telephone connection. One skilled in the art will recognize that there are many other uses for this phone line connection. For example, EPG data may be transmitted to set-top-box 200 via phone line or in the satellite signal 204. One skilled in the art will recognize that the EPG data may be transmitted to set-top-box 200 by various other methods, systems and outside entities. Also, one skilled in the art will recognize that a phone line connection to satellite distributor 104 may represent other communication connections, including, but not limited to, wireless, Internet, or microwave communications connections. Another function of the phone line may be to periodically receive the EPG data. One skilled in the art will also recognize that a phone line connection may permit networked communications with other network-ready devices using the telephone wiring within a subscriber's location.

A satellite set-top-box 200 may also include network connectivity. For example, peripheral interface 224 may include components or interfaces that permit the connection of RJ-45 cabling and transmission of TCP/IP traffic to other connected devices. As another example, a wireless router may be attached via peripheral interface 224 to allow wireless local-area-network (WLAN) data communications using a standard wireless networking protocol such as WiMAX, 802.11b or 802.11g. One skilled in the art will recognize that various other network connections to the set-top-box 200 are possible.

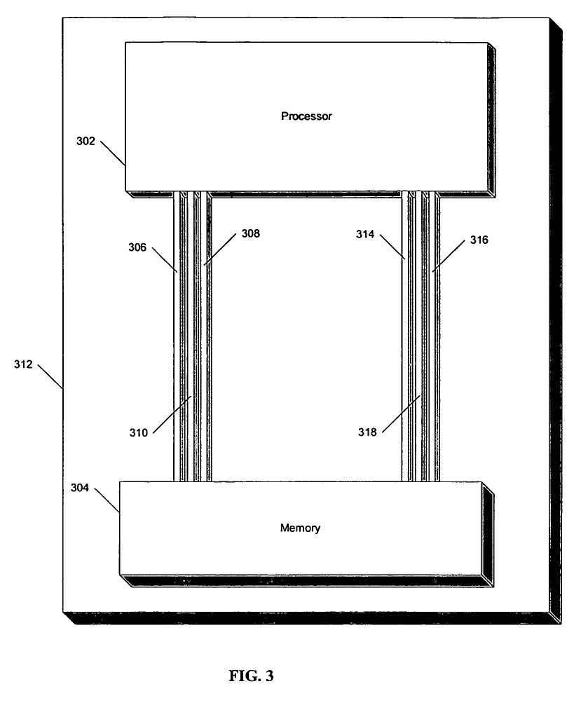

FIG. 3 shows a three-dimensional high level block diagram of one embodiment of the present invention. In this embodiment, PCB 312 is comprised of two layers of dielectric substrate. In other embodiments, PCB 312 may be comprised of multiple dielectric substrates. The dielectric substrate may include, but is not limited to, core, prepreg and adhesive materials used in the PCB substrate lamination process. Where PCB 312 is comprised of two or more adjoining dielectric substrates, one skilled in the art will recognize that PCB 312 may contain connections (e.g., vias) between the two or more adjoining dielectric substrates. One skilled in the art will also recognize that multiple traces [need better wording] may be present within the two or more adjoined dielectric substrates layers of PCB 312 in this circumstance. As set forth in the present embodiment, PCB 312 further contains one or more connected CPU 302 and memory 304 components. One skilled in the art will recognize that one or more memory 304 components may be connected to one or more CPU 302 components. One skilled in the art will further recognize that CPU 302 and memory 304 may be connected in many ways, including, but not limited to, connections via 32-bit and 64-bit interfaces. By way of example, and not of limitation, CPU 302 may take the form of a Broadcom 7038 CPU and memory 304 may take the form of 128 MB DDR-SDRAM operating at 200 MHz and 2.6V. One skilled in the art will recognize that other types of memory 304 may include, but are not limited to, DRAM, EDO, flash, and shadow memory.

As set forth in the present embodiment, two non-reference or critical signal traces 310 and 318 are affixed to the PCB 312 and transmit signals between the CPU 302 and memory 304. In this embodiment, critical signal traces 310 and 318 take the form of copper microstrip transmission lines. One skilled in the art will recognize that critical signal traces may be comprised of various materials that are within the scope of this invention. As further set forth in the present embodiment, reference or ground return traces 306, 308, 314, 316 are also affixed to PCB 312 and substantially correspond to parallel critical signal traces 310 and 318. One skilled in the art will recognize that a substantial correspondence between critical signal traces 310, 318 and ground return traces 306, 308, 314, 316 need not require absolute symmetry between traces. One skilled in the art will also recognize that the orientation and routing on PCB 312 of critical signal traces 310, 318 and ground return traces 306, 308, 314, 316 may take many forms, including, but not limited to, arcs, angles and lines. As set forth by this embodiment, ground return traces 306 and 308 are positioned in parallel to critical signal trace 310 and ground return traces 314 and 316 are positioned in parallel to critical signal trace 318.

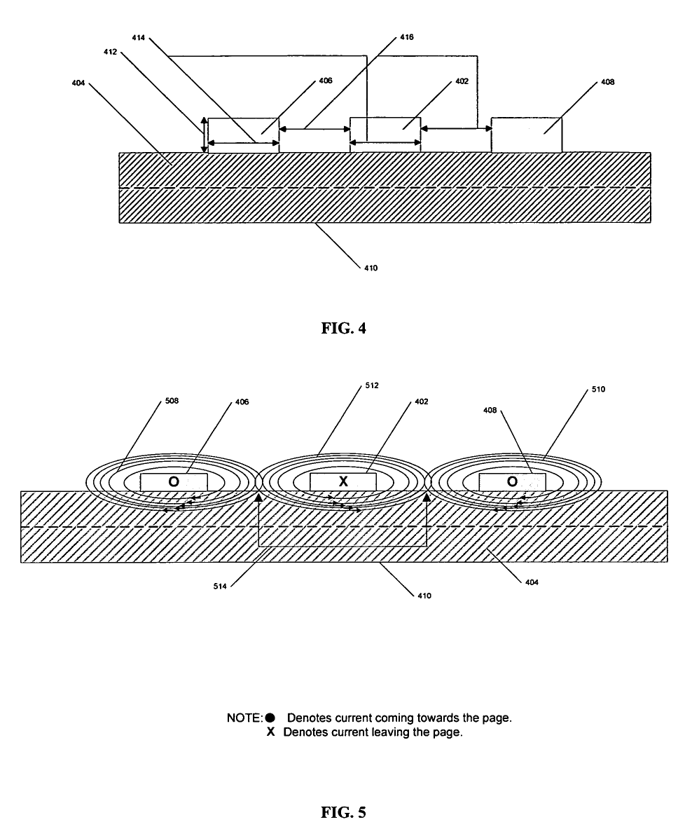

FIGS. 4 and 5 show two cross-sectional diagrams of one embodiment of the present invention.

In particular, FIG. 4 shows the relationship of structural elements of one embodiment of a grounded coplanar waveguide in cross-sectional view. In this embodiment, a non-reference or critical signal trace 402 and two reference or ground return traces 406 and 408 are shown in the same plane affixed to PCB 404. Notably, as indicated by the dashed line, PCB 404 of this embodiment is a two-layer PCB. As shown by FIG. 4, this embodiment does not include a GROUND plane 410 on the reverse plane of PCB 404. One skilled in the art will recognize, however, that other embodiments may include a GROUND plane 410 on the reverse plane of PCB 404 for use as a reference plane for other PCB components. In place of the GROUND plane 410, ground return traces 406 and 408 are oriented parallel to critical signal 402 in the present embodiment. Ground return traces 406 and 408 allow for consistent signal transmission and minimize crosstalk with critical signal trace 402. Ground return traces 406 and 408 further allow significant cost-savings by not requiring addition of a GROUND layer 410 to PCB 404 as ground return traces 406 and 408 transmit the ground or return signals generated by critical signal trace 402. As further set forth in the present embodiment, the height 412 of critical signal trace 402 and ground return traces 406 and 408 may be the same. Similarly, as set forth in the present embodiment, the trace width 414 and spacing 416 may be the same for critical signal trace 402, ground return traces 406 and 408, and the space 416 separating the traces. One skilled in the art will recognize that many factors may vary in order to achieve a certain impedance, including, but not limited to, spacing between signal lines or traces, dielectric properties and signal line or trace dimensions.

FIG. 5 illustrates the field distribution of current for a cross-sectional view of one embodiment of the present invention set forth in FIG. 4. As set forth in this embodiment, ground return traces 406 and 408 sandwich critical signal trace 402 in a parallel orientation on a PCB 404 that omits GROUND layer 410. As illustrated in the present embodiment, a current conducted via critical signal trace 402 results in magnetic fields 512, 508, and 510 where an opposing current is conducted via ground return traces 406 and 408. Specifically, as set forth by the present embodiment, the number of electric field lines or current that penetrates the perpendicular surface area of traces 402, 406 and 408 represents the electrical flux of the present invention. When critical signal trace 402 conducts current, as set forth in the present embodiment, the direction of the magnetic field 512 corresponds to the direction of current that is tangent to magnetic field lines occurring in concentric circles in a plane perpendicular to critical signal trace 402. Similarly, as set forth in the present embodiment, ground return traces 406 and 408 conduct current in a direction opposite critical signal trace 402 and thus result in opposing magnetic fields 508 and 510. As recognized by one skilled in the art, flux adds at the intersection of coincident magnetic fields and subtracts at the intersection of opposing magnetic fields of the present embodiment.

With respect to the present embodiment, the arrangement of magnetic fields 508 and 510 related to ground return traces 406 and 408 and magnetic field 512 related to critical signal trace 402 results in several beneficial effects, including, but not limited to, reducing the overall loop inductance and significantly reducing the propensity for the signal trace to couple to other traces. As set forth in this embodiment, reducing the overall loop inductance allows for lower impedance Zo and improved signal transmission properties.

One skilled in the art will recognize that a transmission line comprising a signal trace and its return path, irrespective of the transmission line cross section, possess electrical properties that can be modeled in lumped circuit model sections as a series R/L with a shunt C/G, where R is the resistance per unit length, L is the inductance per unit length, C is the capacitance per unit length and G is the conductance per unit length. One skilled in the art will further recognize that traces, referred to as GUARD traces, may be connected to the ground plane in a coplanar fashion to increase the isolation between critical signal traces over the ground plane. However, one skilled in the art will also recognize that GUARD traces do not provide a return path for the signal and instead require the presence of a ground plane.

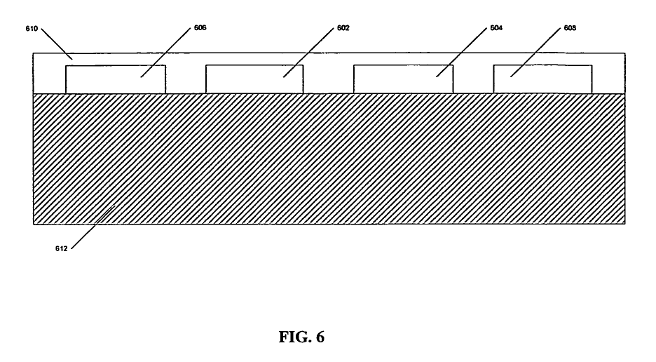

FIG. 6 shows a cross-sectional diagram of a second embodiment of the present invention. In this embodiment, two non-reference or critical signal traces 602 and 604 and two reference or ground return traces 606 and 608 are shown in the same plane. This embodiment also shows that other material, such as a mask 610, may cover traces 602, 604, 606, and 608. As set forth in the present embodiment, limiting each critical signal trace 602 and 604 to a single ground return trace 606 and 608 results in fewer return paths for non-critical signals (such as address or control lines) thereby further reducing board area. As set forth in this embodiment, fewer return paths also permits differential signaling by providing a return path for both signals.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the present invention may also permit high-speed transmissions between two or more microprocessors on a PCB or two or more processor cores on a single microchip. Numerous other changes may be made which will readily suggest themselves to those skilled in the art and which are encompassed in the spirit of the invention disclosed and as defined in the appended claims.

What is claimed is:

1. A method of transmitting signals on a printed circuit board (PCB), the method comprising:
a. transmitting a non-reference signal on said PCB from a processor to memory via a first signal line;
b. transmitting a pair of reference signals from said memory to said processor via second and third signal lines;
c. wherein the said second and third signal lines are in the same plane as the said first signal line; and,
d. wherein the arrangement of the said second and third signal lines corresponds to the said first signal line.

2. A method according to claim 1, wherein the printed circuit board does not contain a ground plane.

3. A method according to claim 1, wherein the said memory is DDR SDRAM.

4. A method of transmitting memory signals on a printed circuit board, the method comprising:
a. transmitting a critical signal from a processor to memory via a first signal line;
b. transmitting a pair of reference signals from said memory to said processor via second and third signal lines; and,
c. wherein the said pair of reference signals are transmitted in the same plane and parallel to the said critical signal.

5. A method according to claim 4, wherein the printed circuit board does not contain a ground plane.

6. A method according to claim 4, wherein the memory is DDR SDRAM.

7. A grounded coplanar waveguide comprising:
a. a dielectric substrate;
b. a first signal line arranged on said dielectric substrate;
c. a second signal line arranged on said dielectric substrate, wherein said second signal line is in the same plane and parallel to a first side of said first signal line;
d. a third signal line arranged on said dielectric substrate, wherein said third signal line is in the same plane and parallel to a second side of said first signal line;
e. a uniform intermediate space separating the said second signal line and the said third signal line from the said first signal line; and,
f. wherein the said second signal line and said third signal line transmit a reference signal for the said first signal line.

8. The grounded coplanar waveguide according to claim 7, wherein the loop inductance per unit length, capacitance per unit length, mutual inductance per unit length, are a uniform length.

9. The grounded coplanar waveguide according to claim 7, wherein the uniform intermediate spacing varies by a range of mils.

10. A method of transmitting signals on a printed circuit board (PCB), the method comprising:
a. transmitting a non-reference signal in a plane of said PCB from a source to a destination via a first signal line;
b. transmitting a pair of reference signals from said destination to said source via second and third signal lines; and,
c. wherein the said pair of reference signals provide a return path in the same plane for said non-reference signal.

11. The method of transmitting signals according to claim 10, wherein the arrangement of the said pair of reference signals substantially corresponds to the said critical signal.

12. The method of transmitting signals according to claim 10, wherein the said corresponding pair of reference signals are parallel to the said critical signal.

13. A grounded coplanar waveguide comprising:
a. a critical signal;
b. a pair of reference signals; and,
c. a grounding means for sending a ground return signal in the same plane as the critical signal and said pair of reference signals.
